(19) United States
(12) Patent Application Publication
(10) Pub. No.: US 2020/0110580 A1
(43) Pub. Date: Apr. 9, 2020

(54) STORING FLOATING POINT VALUES IN INTEGER REPRESENTATIONS FOR HISTOGRAM RECORDING

(71) Applicant: CA, Inc., New York, NY (US)

(72) Inventor: Christopher Phillip Bonnell, Longmont, CO (US)

(21) Appl. No.: 16/151,669

(22) Filed: Oct. 4, 2018

(51) Int. Cl. G06F 7/483

(52) U.S. Cl. CPC G06F 7/483

(57) ABSTRACT

Floating point values can be efficiently captured into integer representations that preserve fidelity at a specified significant digits resolution for histogram recording. This essentially uses a memory space allocated for an integer as a store for a custom representation of a floating point value. A floating point value is split into exponent and fraction components. The fraction component is manipulated according to a significant digits resolution for a histogram to generate an integer mantissa without fraction bits. To accommodate floating point values having different signs without the overhead of indicating a sign, the exponent and the integer mantissa are moved into a positive value range. The exponent is then stored into the half of an integer type space corresponding to the most significant bits and the integer mantissa is stored into the remaining half

### BACKGROUND

The disclosure generally relates to the field of data processing, and more particularly to arithmetic processing and calculating.

Histograms have been employed to approximate data distributions in application performance data. A high dynamic range (HDR) histogram supports recording and analyzing of sampled data value counts across a configurable integer value range with configurable value precision within the range. Value precision is expressed as the number of significant digits in the value recording and provides control over value quantization behavior across the value range and the subsequent value resolution.

### BRIEF DESCRIPTION OF THE DRAWINGS

Embodiments of the disclosure may be better understood by referencing the accompanying drawings.

FIG. 1 is a conceptual diagram of a cloud service recording distribution of floating point values of different signs without a priori knowledge of an upper bound into a histogram with a significant digits resolution setting.

FIG. 2 is a flowchart of example operations for storing a floating point value into an integer type variable for histogram recording based on a significant digits resolution set for the histogram.

FIG. 3 is a flowchart of example operations for recovering a floating point value from an integer representation of the floating point value with fidelity according to the significant digits resolution.

FIG. 4 depicts an example computer system with a Significant Digits Resolution Based Float Converter for Histogram Recording.

### DESCRIPTION

The description that follows includes example systems, methods, techniques, and program flows that embody aspects of the disclosure. However, it is understood that this disclosure may be practiced without these specific details. In other instances, well-known instruction instances, protocols, structures and techniques have not been shown in detail in order not to obfuscate the description.

Introduction

The HDR histogram structure can be used for summarizing streaming data. However, the HDR histogram structure requires that you have some rough knowledge of the streaming data. The required knowledge includes sign of the streaming data and a maximum value. These limitations can cause expensive map-reduce to be chosen over HDR histogram.

Overview

Floating point values in streaming data can be efficiently captured into custom integer representations that preserve fidelity at a specified significant digits resolution for histogram recording. With the disclosed technique, a service application (software as a service) can be agnostic as to the data source and accurately record distribution of floating point values into a histogram at a specified resolution. With the integer representations, summarization with a histogram can be done on-the-fly and in-memory (i.e., in system memory). Furthermore, the disclosed technique can accommodate changes in data fields.

Example Illustrations

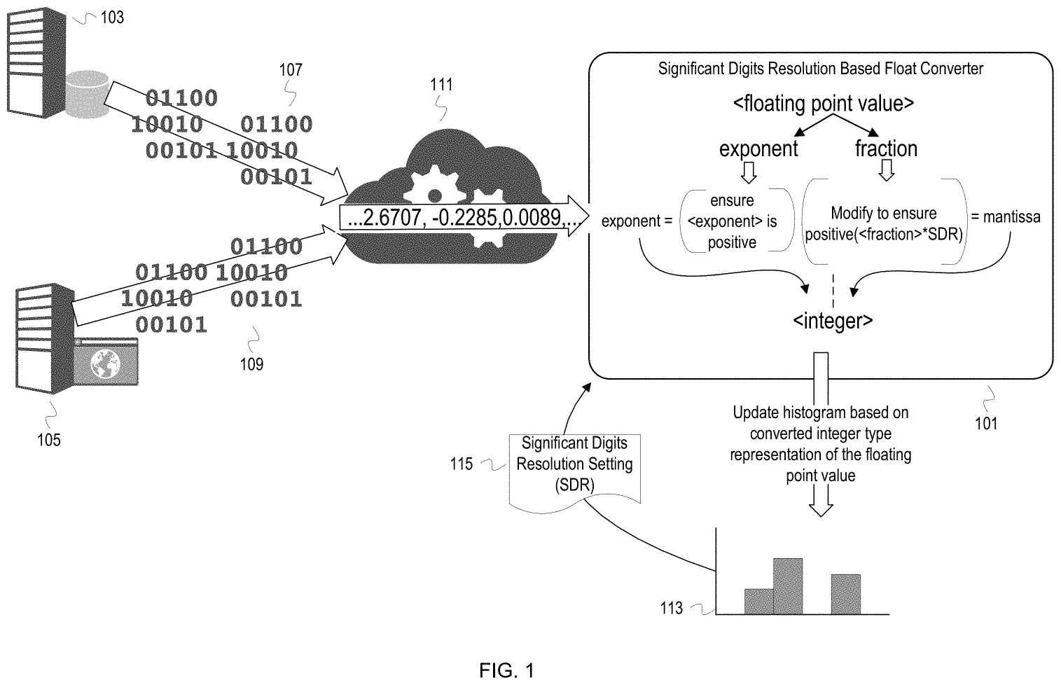

FIG. 1 is a conceptual diagram of a cloud service recording distribution of floating point values of different signs without a priori knowledge of an upper bound into a histogram with a significant digits resolution setting. A cloud service 111 or software as a service (SaaS) receives data streams 107, 109 from an agent on a database server 103 and an agent on a distributed application component 105, respectively. The database server 103 and the application component 105 are examples of data sources. A data source may be an intermediary service or application that collects application performance data and streams the data or selected data sets to the service 111. The data streams include floating point values with both positive and negative signs.

The service 111 includes a significant digits resolution (SDR) based float converter 101. The SDR based float converter 101 determines a SDR setting 115 for a histogram structure 113. The SDR setting 115 indicates the significant digits to be preserved for the histogram structure 113 to summarize distributed of values from the data streams 107, 109. When the converter 101 captures a floating point value from a data stream, the converter breaks the floating point value down into its binary significand and an integral exponent for two. The binary significand is also referred to as the fraction because it is a value between 0.5 (inclusive) and 1 (exclusive):

floating point value=fraction*2^{exponent}

After breaking the floating point value into the fraction and the exponent, the converter 101 adjusts the values for storing into an integer type representation of the floating point value. The converter 101 calculates a mantissa as an integer product of the fraction and SDR setting to adjust the binary significand to the SDR. To allow for any signed floating point value, the converter 101 adds the maximum positive value possible for an integer in the programming language of the program handling the floating point values. The converter 101 then stores the resulting mantissa bits into the most significant upper half bits of an integer variable and stores the resulting exponent into the lower half bit of the variable. The converter 101 then passes the value stored into the integer type variable to a process or program that updates the histogram structure 113 based on the value stored in the integer type variable.

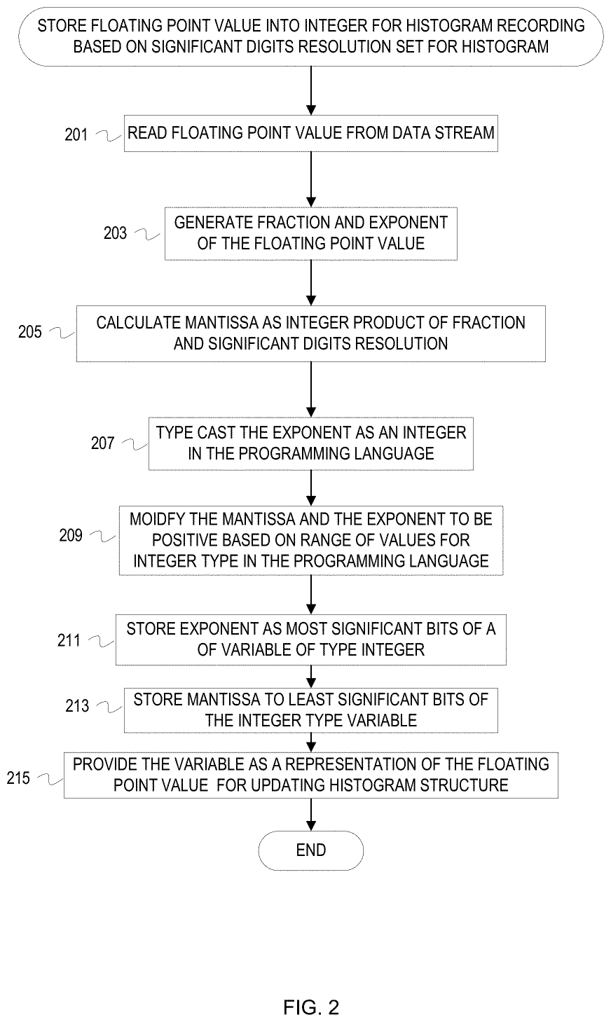

FIG. 2 is a flowchart of example operations for storing a floating point value into an integer type variable for histogram recording based on a significant digits resolution set for the histogram. The description of FIG. 2 refers to a converter as performing the example operations for consistency with FIG. 1, although it should be appreciated that a variety of naming of program code to carry out the example operations could be used based on, as examples, platform, programming language, and developer preferences.

As part of a program that analyzes floating point values from a data source(s), a converter reads a floating point value from a data stream (201). While embodiments are not limited to reading floating point values from data streams, reading from a data stream is used as an example since efficiency is important when analyzing data being communicated via data stream. For instance, floating point values may be stored in a buffer of a finite size and cause pack pressure on the data source if not read at a sufficient rate. The efficiency of the disclosed technique can aid in achieving a sufficient rate.

The converter generates a fraction and an exponent from the floating point value (203). Many programming languages offer a function that accepts as an argument a floating point value and returns a binary significand or normalized fraction as a floating point data type (i.e., in floating point format) and an integral exponent as an integer data type (i.e., in integer format). When storing a number into floating point format, approximations may be made. Despite two floating point values presenting as the same when displayed, the stored floating point value may be different and result in an unexpected result when compared. This is obviously problematic when recording into a histogram.

The converter then modifies the normalized fraction to comport with the significant digits resolution set for the histogram (205). The converter modifies the normalized fraction by calculating an integer product of the fraction and the significant digits resolution with a fractional of the product removed (i.e., truncates a fractional part of the resulting product). This description refers to this product as the mantissa instead of modified significand to help distinguish the resulting values even though mantissa, significand and fraction are synonymous.

After applying the significant digits resolution to the fraction to generate the mantissa as an integer data type, the converter type casts the exponent as an integer data type (207). The type casting is in accordance with the programming language in which the other manipulations of the floating point value are performed. After the type casting, the mantissa and the exponent are stored in the integer format.

With both the exponent and the mantissa in the integer format, the converter modifies the mantissa and the exponent to be positive values based on the range of values for an integer type in the underlying programming language (209). To do this, the converter adds the maximum positive value for an integer in the programming language to each of the mantissa and the exponent. This effectively shifts the mantissa and exponent regardless of sign of the floating point value. Without the overhead of a sign bit, the histogram will update the distribution counts properly even though a first floating point value is −23.3456 and a second floating point value is 23.3456.

After the modification for the resolution setting and for sign of the original floating point value, the converter stores the modified mantissa and exponent into a variable of integer type. The converter stores the exponent into the most significant bits of the integer type variable (211). For example, the converter shifts the bits of the exponent over the lower half of the variable (e.g., shifts the exponent bits in 16 bits assuming the integer data type has a 32 bit format. The converter then stores the mantissa to least significant bits of the integer type variable (213). The converter can add the mantissa to the variable to store the bits of the mantissa into the least significant bits of the variable. The value stored in the integer type variable is now a representation of the floating point value from the data stream. The converter provides the representation of the floating point value for updating a histogram structure since the comparison of integer data types does not have the same issues as floating point values (215). While the representation of the floating point value in the integer data type variable can be used for properly recording distributions of floating point values to the selected resolution of significant digits, these representations of floating point values should not be used in math operations intended for the floating point values.

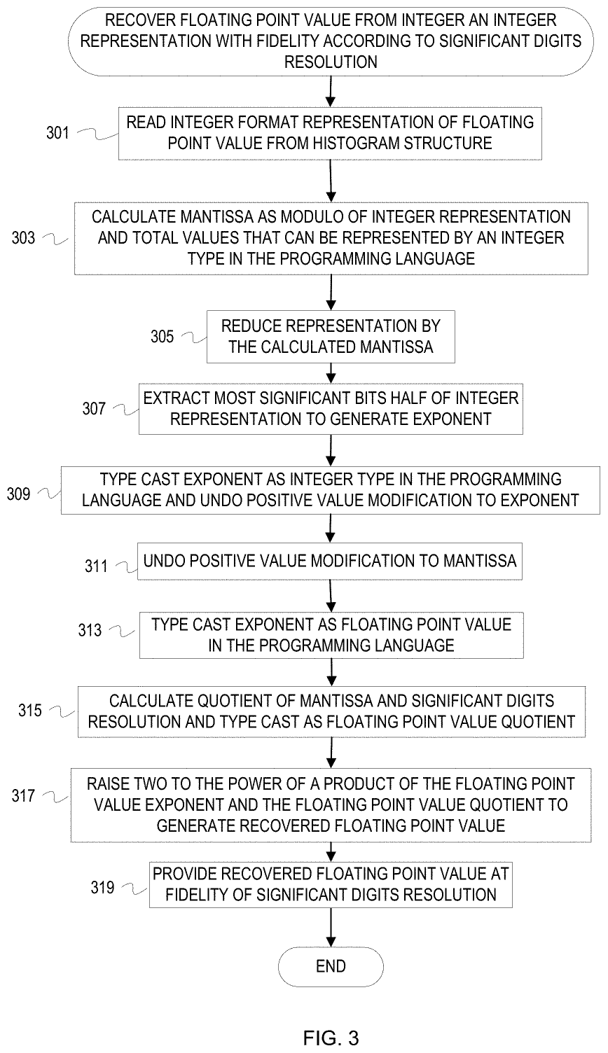

For various reasons, a program may recover the floating point values from the histogram (e.g., validate the histogram or generate a different histogram at a lower resolution). While the original floating point values cannot be recovered with more significant digits than set for the histogram, the floating point values can be recovered accurately at the resolution of the histogram. FIG. 3 is a flowchart of example operations for recovering a floating point value from an integer representation of the floating point value with fidelity according to the significant digits resolution. The description of FIG. 3 again refers to the converter as performing the example operations for consistency despite possible implementation variations.

The converter reads an integer format representation of a floating point value from a histogram structure or from a variable associated with the histogram structure (301). This may in response to a request to display the values corresponding to the buckets or bins of the histogram or validation of the distribution of values.

After reading the integer format representation (“integer representation”) of the floating point value, the converter performs operations to recover the floating point value with significant digits at the resolution of the histogram. The converter calculates a mantissa value as a modulo of the integer representation and the total number of integer values that can be represented with the integer data type of the programming language (303). The converter then reduces the integer representation by the calculated mantissa (305). This reduction can be a subtraction operation that zeroes out the lower half of the integer representation with exponent bits remaining in the integer representation. The converter extracts the upper half most significant bits of the reduced integer representation to generate the exponent value (307). With a 32 bit integer format, the converter can shift the integer representation 16 bits down to generate the exponent value.

The converter then modifies the exponent value and the mantissa to account for modification to the value when stored that allows for different signs. In the above description, this was done by adding the maximum positive value to each of the mantissa and exponent before storing into the integer representation. To avoid any floating point optimizations by a compiler, the converter type casts the exponent as an integer type before undoing the earlier modification when storing (309). The converter also undoes the positive value modification or sign accommodating modification done when storing (311). If this modification was not done when storing the floating point value into integer representation (e.g., incoming floating point values are a same sign), then the corresponding “undo” sign accommodating operations need not be performed.

With the exponent and mantissa components, the converter then performs operations to calculate the floating point value represented at the set resolution. The converter type casts the exponent as a floating point type to put the exponent value into floating point format (313). The converter then calculates a quotient of the mantissa and the significant digits resolution (315). The converter type casts the quotient as a floating point data type (315). Since computing systems are binary, the converter raises two to the power of a product of the floating point exponent and the floating point quotient (317). The resulting value is the floating point value recovered at the significant digits resolution. The converter then returns the recovered floating point value (319).

Below is example program code for storing a floating point value into an integer representation and example program code to recover a floating point value at the histogram resolution from an integer representation. The first program code customfloatstore receives a value in a floating point variable x and returns an integer representation to be recorded against a histogram structure m. The second program code recover receives an unsigned 32 bit integer and returns a 64 bit floating point value.

func (m Histogram) customfloatstore(x float64) uint32 {
fr, exp := math.Frexp(x) ///break the floating point that you capture
into a fraction and integral exponent
mantissa := int32(math.Trunc(fr*float64(m.MulRes))) + 32768 ///truncate
a product of the fraction and sig and then push to positive
expPart := int32(exp) + 32768 /// also ensure positive
return uint32((expPart << 16) + mantissa) ///store into the integer
value
}
func [symbol] m Histogram [symbol] recover(x uint32) float64 {
mantissa :=(x % 65536)
expPart := (x − mantissa) >> 16
return math.Pow(2., float64(int32(expPart-32768)) * (float64(mantissa) −
32768.) /
float64(m.MulRes)

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

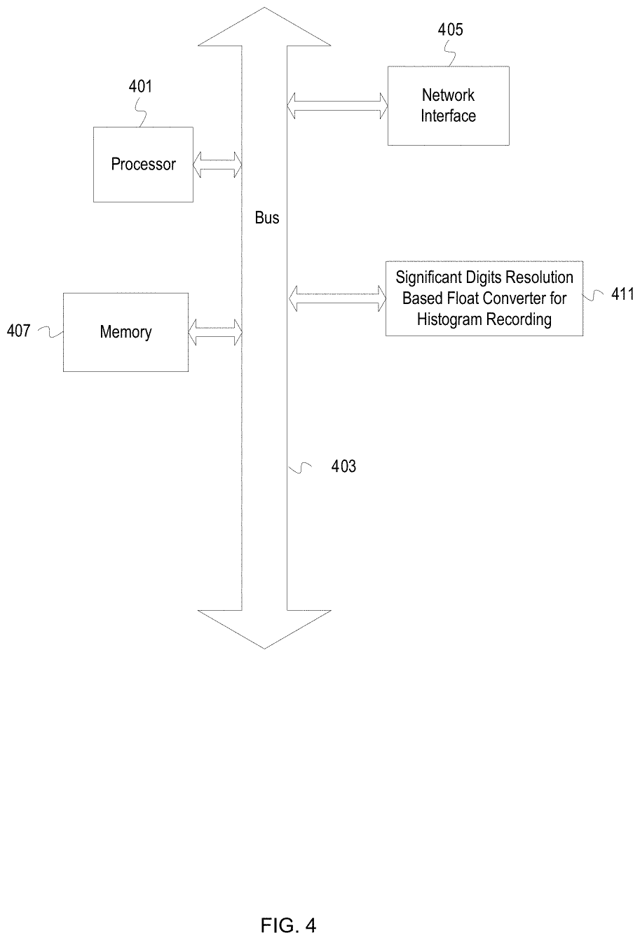

FIG. 4 depicts an example computer system with a Significant Digits Resolution Based Float Converter for Histogram Recording. The computer system includes a processor 401 (possibly including multiple processors, multiple cores, multiple nodes, and/or implementing multi-threading, etc.). The computer system includes memory 407. The memory 407 may be system memory or any one or more of the above already described possible realizations of machine-readable media. The computer system also includes a bus 403 and a network interface 405 (e.g., wireless interface components and/or wired interface components). The system also includes a significant digits resolution based float converter 411 for histogram recording. The converter 411 splits a floating point value into its fraction and exponent components and then manipulates those components as described above based on a histogram resolution. The resulting component values are stored into an integer format, effectively taking an integer variable and using it as a custom store for floating point values for a histogram. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

While the aspects of the disclosure are described with reference to various implementations and exploitations, it will be understood that these aspects are illustrative and that the scope of the claims is not limited to them. In general, techniques for storing a floating point value into an integer data type variable at a resolution set for a histogram as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
determining a significant digits resolution setting for a histogram structure;
determining a fraction and an exponent for an observed value of floating point type as defined by a programming language;
calculating a mantissa as a first integer product of the fraction and the significant digits resolution setting;
type casting the mantissa and the exponent as values of integer type as defined by the programming language; and
storing the exponent in a top half of a representation of the observed value and adding the mantissa to the representation, wherein the representation is of integer type.

2. The method of claim 1, wherein the significant digits resolution setting indicates significant digits for comparison of values when updating the histogram structure.

3. The method of claim 1 further comprising updating the histogram structure based on the representation of the observed value.

4. The method of claim 1 further comprising modifying the mantissa and the exponent to ensure positive values based on the range of values allowed for an integer type in the programming language.

5. The method of claim 4, wherein modifying to ensure positive values comprises adding a maximum positive integer value for type integer in the programming language to each of the mantissa and the exponent.

6. The method of claim 1, wherein storing the exponent in the top half of the representation comprises shifting the exponent into the top half of the representation.

7. The method of claim 1 further comprising recovering the observed value from the representation, wherein the observed value is recovered with a fidelity corresponding to the significant digits resolution.

8. The method of claim 7, wherein recovering the observed value from the representation comprises:
recovering the mantissa as a remainder of the representation divided by the number of values that can be represented with an integer type value in the programming language;
extracting the exponent from the top half of the representation;
type casting the mantissa and the exponent as floating point values; and
calculating the recovered observed value as two raised to a power of a second integer product of the exponent and a quotient of the recovered mantissa and the significant digits resolution setting.

9. The method of claim 8, further comprising reducing the extracted exponent and the recovered mantissa each by a maximum value for an integer type in the programming language, wherein the reducing is prior to calculating the recovered observed value.

10. The method of claim 1 further comprising reading the observed value from a data stream of values generated from application monitoring.

11. A non-transitory, computer-readable medium having instructions stored thereon that are executable by a computing device to perform operations comprising:
determining a significant digits resolution value for a histogram structure;
generating a fraction and an exponent from a first floating point value;
calculating a mantissa as a first integer product of the fraction and the significant digits resolution value;
type casting the mantissa and the exponent as integer type as defined by a programming language; and
storing the exponent in most significant bits of an integer type representation of the first floating point value and the mantissa in least significant bits of the integer type representation.

12. The non-transitory, computer-readable medium of claim 11, wherein data types are defined by the programming language.

13. The non-transitory, computer-readable medium of claim 11, wherein the significant digits resolution indicates significant digits for comparison of values when updating the histogram structure.

14. The non-transitory, computer-readable medium of claim 11, wherein the instructions stored thereon are executable by a computing device to perform operations further comprising adding a maximum value possible for an integer type in the programming language to each of the mantissa and the exponent after type casting and prior to storing into the integer type representation.

15. The non-transitory, computer-readable medium of claim 11, wherein storing the exponent in the most significant bits of the integer type representation comprises shifting bits of the exponent into the most significant bits of the representation.

16. The non-transitory, computer-readable medium of claim 11, wherein the integer type is an unsigned integer type.

17. The non-transitory, computer-readable medium of claim 11, wherein the instructions stored thereon are executable by a computing device to perform operations further comprising recovering from the integer type representation the floating point value with a fidelity corresponding to the significant digits resolution value.

18. The non-transitory, computer-readable medium of claim 17, wherein recovering the floating point value with a fidelity corresponding to the significant digits resolution value comprises:
recovering the mantissa as a remainder of the integer type representation divided by the number of values that can be represented with an integer type value in the programming language;
extracting the exponent from the most significant bits of the integer type representation;
type casting the mantissa and the exponent as floating points; and
generating the recovered floating point value as two raised to a power of a second integer product of the exponent and a quotient of the recovered mantissa and the significant digits resolution value.

19. An apparatus comprising:
a processor; and
a computer-readable medium having instructions stored thereon that are executable by the processor to cause the apparatus to,
determine a significant digits resolution value for a histogram structure;
invoke a function in a programming language to generate a fraction and an exponent from a first floating point value;
calculate a mantissa as a first integer product of the fraction and the significant digits resolution value;
type cast the mantissa and the exponent as integer type as defined by the programming language; and
generate an integer type representation of the floating point value with the integer type mantissa and the integer type exponent, wherein the instructions executable to generate the integer type representation comprise instructions executable by the processor to cause the apparatus to store the exponent into a most significant bits portion of the integer type representation and store the mantissa into a remaining portion of the integer type representation.

20. The apparatus of claim 19, wherein the instructions to store the exponent into a most significant bits portion of the integer type representation and store the mantissa into a remaining portion of the integer type representation comprise instructions to shift the exponent into the most significant bits portion and add the mantissa to the integer type representation after shifting in the exponent.
